(19) United States
(12) Patent Application Publication
(10) Pub. No.: US 2015/0280299 A1
(43) Pub. Date: Oct. 1, 2015

(54) WAVEGUIDE BAND PASS FILTER USING SHORT-CIRCUIT STUB FOR REJECTION PERFORMANCE IMPROVEMENT

(71) Applicant: Electronics and Telecommunications Research Institute, Daejeon (KR)

(72) Inventors: Hong Yeol LEE, Cheongju-si Chungcheongbuk-do (KR); Man Seok UHM, Daejeon (KR); Chang Soo KWAK, Daejeon (KR); So Hyeun YUN, Daejeon (KR); In Bok YOM, Daejeon (KR)

(21) Appl. No.: 14/625,131

(22) Filed: Feb. 18, 2015

(30) Foreign Application Priority Data
Mar. 27, 2014 (KR) 10-2004-0035739

(51) Int. Cl. H01P 1/207; H01P 1/208

(52) U.S. Cl. CPC H01P 1/207; H01P 1/2002; H01P 1/208

(57) ABSTRACT

Disclosed is a waveguide resonator for a band pass filter, which configures a short-circuit stub low-frequency band pass filter in a waveguide resonator to pass a low frequency and reject a stop band, thereby effectively removing undesired spurious or harmonic components on a frequency spectrum.

### CROSS-REFERENCE TO RELATED APPLICATIONS

This application claims priority to and the benefit of Korean Patent Application No. 10-2004-0035739 filed in the Korean Intellectual Property Office on Mar. 27, 2014, the entire contents of which are incorporated herein by reference.

### TECHNICAL FIELD

The present invention relates to a waveguide resonator for band pass filtering, and particularly, to a waveguide resonator for band pass filtering, which performs a low-frequency band pass filter function by configuring a short-circuit stub in a waveguide resonator to reject a stop band, thereby effectively removing undesired spurious or harmonic components on a frequency spectrum.

### BACKGROUND ART

In general, when a waveguide band pass filter (BPF) having an E-plane structure using a TE₁₀ mode is used, undesired spurious or harmonic components are generated on a frequency spectrum. In particular, in the case of a satellite frequency using both transmission and reception bands, since spurious components generated in a contiguous band deteriorate a rejection feature, the spurious components exert a direct influence on smooth communication. In particular, in the case of a Ku-band satellite frequency, the reception band is in the range of 10.7 to 12.75 GHz and the transmission band is in the range of 13.75 to 14.5 GHz, and as a result, an interval between the transmission and reception bands is very small as approximately 1 GHz, in general. Accordingly, in the case of a Ku-band reception filter, when the spurious components are generated around the band, that is, in the transmission band, a rejection feature of the reception filter for the transmission band significantly deteriorates.

Prior documents for rejection performance improvement in the related art include EU Patent ‘EP 1161775 A1’ opened in 2001 and ‘Spurious Free D. R. TE Mode Band Pass Filter’ published by IEEE MTT-S in 1994.

A band pass filter implemented in EU Patent ‘EP 1161775 A1’ has the band pass filter at the center and low-frequency band pass filters at both sides thereof and includes input and output terminals and a converter unit positioned at both sides of an outermost edge. Each of the input and output terminals and the converter unit is configured in a unit form, and as a result, only a required unit is implemented to be used. Among them, the low-frequency band pass filter unit is used to implement additional rejection performance when the band pass filter unit cannot implement desired rejection performance by a harmonic feature, and the like. However, in this structure, an additional low-frequency band pass filter is used, and as a result, the size of the filter may increase and loss increases as much.

A thesis, ‘Spurious Free D. R. TE Mode Band Pass Filter’ published by the IEEE MTT-S discloses a dielectric filter structure that can basically transmit the TE₁₀ mode. Herein, a rectangular parallelepiped dielectric resonator is a block form having a high dielectric constant and a block having a low dielectric constant is used between the dielectric resonators for coupling the dielectric resonators. Since the sizes of cross-sections of the block having the high dielectric constant and the block having the low dielectric constant are the same as each other, it is characterized in that a higher order mode for the TE₁₀ mode is not generated. The structure is advantageous in that the dielectric resonator is used to reduce the size, but since an outermost peripheral surface of a dielectric needs to be plated with a conductor material or the dielectric needs to be put by processing a metallic block, manufacturing and implementing the structure are complicated and difficult, and as a result, reproducibility may deteriorate.

### SUMMARY OF THE INVENTION

The present invention has been made in an effort to provide a waveguide resonator for a band pass filter, which can pass a low frequency (e.g., a reception band) and reject a stop band by a short-circuit stub low-frequency band pass filter, and effectively remove spurious or harmonic components in the waveguide resonator for the band pass filter adopted for band pass filtering to a satellite communication duplexer using both transmission and reception bands like satellite communication.

An exemplary embodiment of the present invention provides a waveguide resonator for band pass filtering, including: a resonator coupled in a resonance mode through inductive irises at both sides between an input terminal and an output terminal; and a short-circuit stub formed on one surface of the resonator vertically to an RF signal progress direction.

The RF signal may be transmitted in a TE₁₀ mode.

The resonator may have a cavity form or a form in which the resonator is filled with a dielectric.

The short-circuit stub may be used as a low-frequency band pass filter and the short-circuit stub may be used to remove spurious or harmonic components.

In the short-circuit stub, a corresponding groove may be designed to have a predetermined length, width, or depth to achieve a predetermined electrical feature.

The waveguide resonator may have a structure in which the plurality of short-circuit stubs are formed on one surface of the resonator and the plurality of corresponding short-circuit stubs are separated by a predetermined distance to achieve the predetermined electrical feature.

The waveguide resonator may have a structure in which the plurality of resonators are formed between the input terminal and the output terminal and the plurality of corresponding resonators are coupled to each other in the resonance mode through the inductive irises.

Another exemplary embodiment of the present invention provides a waveguide filter including: a band pass filter formed by a waveguide resonator; and a low-frequency band pass filter having a short-circuit stub form, which is formed integrally with the band pass filter, wherein the waveguide filter is applied to a satellite communication duplexer to receive an RF signal in a reception band through the band pass filter and used to remove spurious or harmonic components through the low-frequency band pass filter.

Yet another exemplary embodiment of the present invention provides a method for receiving an RF signal by using a waveguide resonator, including: band-pass-filtering an RF signal by using a resonator coupled in a resonance mode through inductive irises at both sides between an input terminal and an output terminal; and passing a low frequency and removing spurious or harmonic components by using a short-circuit stub formed on one surface of the resonator vertically to an RF signal progress direction.

The RF signal may be transmitted in a TE₁₀ mode through the resonator.

The resonator may have a cavity form or a form in which the resonator is filled with a dielectric.

In the short-circuit stub, a corresponding groove may be designed have a predetermined length, width, or depth to achieve a predetermined electrical feature.

A structure may be used, in which the plurality of short-circuit stubs are formed on one surface of the resonator and the plurality of corresponding short-circuit stubs are separated by a predetermined distance to achieve the predetermined electrical feature.

A structure may be used, in which the plurality of resonators are formed between the input terminal and the output terminal and the plurality of corresponding resonators are coupled to each other in the resonance mode through the inductive irises.

According to an exemplary embodiment of the present invention, a waveguide resonator for a band pass filter passes a low frequency (e.g., a reception band) by a short-circuit stub low-frequency band pass filter in band pass filtering in a duplexer using both transmission and reception bands like satellite communication and rejects a stop band to effectively remove spurious or harmonic components.

Since a short-circuit stub can be integrally provided together with a waveguide in addition to improvement of electrical performance, an entire size of the filter does not increase and since an integrated body including the short-circuit stub can be simultaneously processed at the time of mechanically processing the filter, the waveguide resonator is easily manufactured and reproducibility is also excellent.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

### BRIEF DESCRIPTION OF THE DRAWINGS

FIG. 1A is a perspective view of a waveguide resonator having a short-circuit stub incorporated therein according to an exemplary embodiment of the present invention.

FIG. 1B is a front view of the waveguide resonator of FIG. 1A viewed from the front.

FIG. 1C is a plan view of the waveguide resonator of FIG. 1A viewed from the top.

FIG. 2 illustrates an equivalent circuit model for the short-circuit stub according to the exemplary embodiment of the present invention.

FIG. 3 illustrates an example of a 12-th band pass filter using the waveguide resonator having the short-circuit stub incorporated therein according to an exemplary embodiment of the present invention.

FIG. 4 is an electrical transfer feature graph in a Ku band of the 12-th band pass filter using the waveguide resonator having the short-circuit stub incorporated therein according to the exemplary embodiment of the present invention.

FIG. 5 is an electrical transfer feature graph in a wide frequency domain of the 12-th band pass filter using the waveguide resonator having the short-circuit stub incorporated therein according to the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, the present invention will be described in detail with reference to the accompanying drawings. In this case, like reference numerals refer to like elements in the respective drawings. Further, a detailed description of an already known function and/or configuration will be skipped. In contents disclosed hereinbelow, a part required for understanding an operation according to various exemplary embodiments will be described in priority and a description of elements which may obscure the spirit of the present invention will be skipped. Further, some components of the drawings may be enlarged, omitted, or schematically illustrated. An actual size is not fully reflected on the size of each component and therefore, contents disclosed herein are not limited by relative sizes or intervals of the components drawn in the respective drawings.

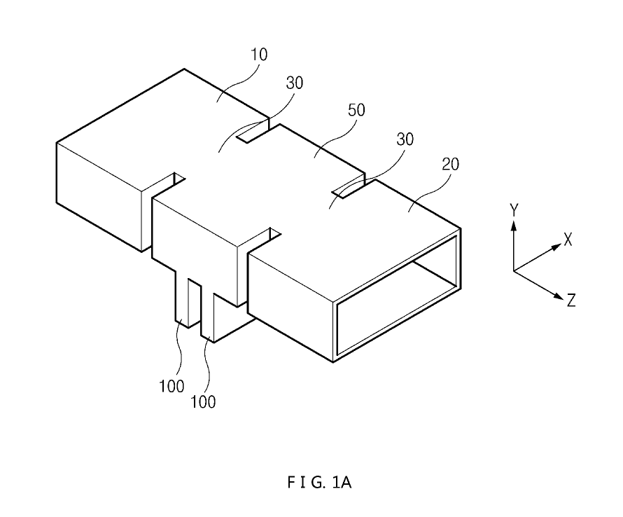

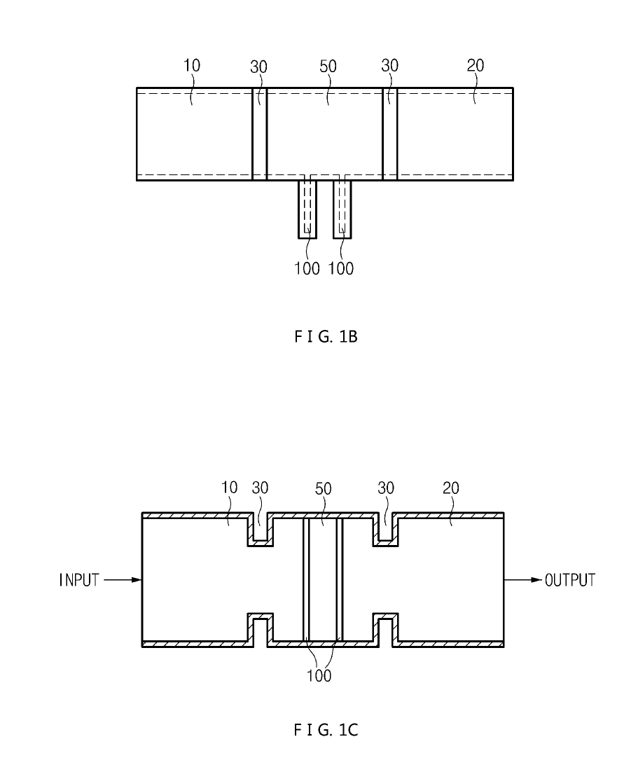

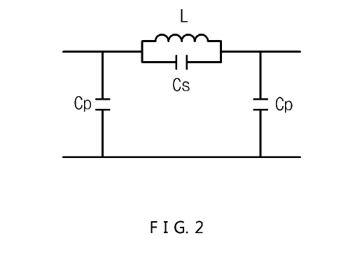

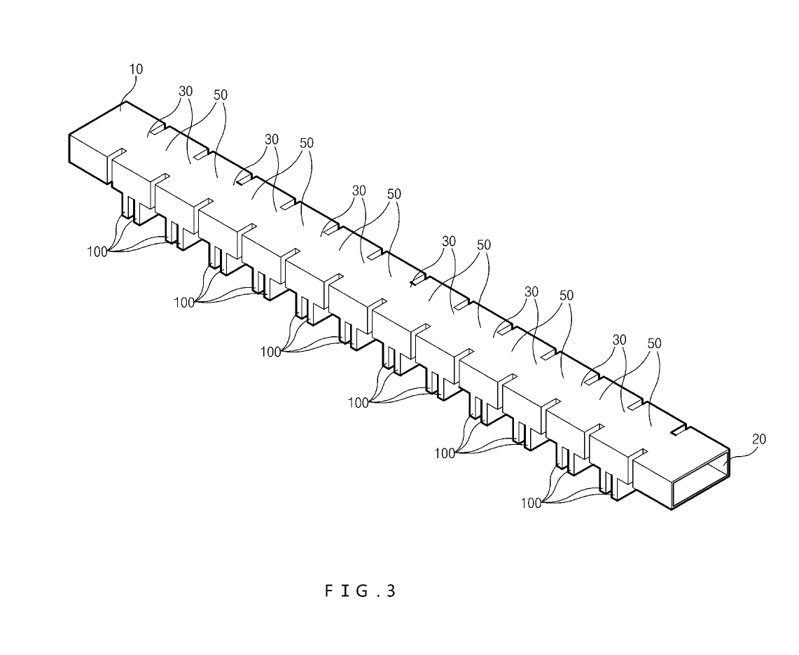

FIG. 1A is a perspective view of a waveguide resonator having a short-circuit stub incorporated therein according to an exemplary embodiment of the present invention. FIG. 1B is a front view of the waveguide resonator of FIG. 1A viewed from the front. FIG. 1C is a plan view of the waveguide resonator of FIG. 1A viewed from the top.

Referring to FIGS. 1A to 1C, the waveguide resonator according to the exemplary embodiment of the present invention includes a resonator 50 coupled through inductive irises 30 at both sides between an input terminal 10 for inputting a radio frequency (RF) signal and an output terminal 20 for outputting the RF signal and the resonator 50 includes a plurality of short-circuit stubs 100 serving as a low-frequency band pass filter that passes a low frequency (e.g., a reception band of satellite communication) and rejects a stop band (e.g., a transmission band of the satellite communication) to effectively remove spurious or harmonic components. Herein, two short-circuit stubs 100 are preferably provided in the resonator 50, but in some cases, only one short-circuit stub 100 or three or more short-circuit stubs 100 may be provided in each resonator 50.

First, the waveguide resonator according to the exemplary embodiment of the present invention is a rectangular waveguide form for the RF signal such as the satellite signal (e.g., Ku-band signal) input into the input terminal 10 to be progressed in the TE₁₀ mode and may be manufactured by being processed with a predetermined metallic material. The inductive irises 30 for signal resonance is coupled to both sides of the resonator 50 in a signal progress direction Z by impedance matching. The resonator 10/20/50 and the inductive iris 30 are coupled in a resonance mode to electrically acquire a predetermined band pass feature by appropriately designing the width of a hole of the inductive iris 30 in a direction vertical to the signal progress direction Z and the length of a hole in the signal progress direction Z, and as a result, a band pass signal of the RF signal received from the input terminal 10 having a conduit form may be output through the output terminal 20 having the conduit form. A subsequent circuit is connected to the output terminal 20 to demodulate the corresponding signal.

As illustrated in the figure, two short-circuit subs 100 are provided in the resonator 50 and the respective short-circuit stubs 100 may be manufactured to be processed in such a manner that a predetermined groove is formed at a metallic protrusion of the bottom integrally with the resonator 50. However, the present invention is not limited thereto and in some cases, the short-circuit stub 100 is separately manufactured and thereafter, the short-circuit stub 100 and the resonator 50 may be assembled so that the groove of the short-circuit stub 100 is positioned at a hole appropriately formed on the bottom of the resonator 50. Further, it is illustrated that the short-circuit stub 100 crosses up to both ends of the resonator 50 in the direction X vertical to the signal progress direction Z, but in some cases, the width of the short-circuit stub 100 may be appropriately designed to be smaller than that of the resonator 50.

In the respective short-circuit stubs 100, an inductor L and a capacitor Cs connected in parallel are changed to a form in which the inductor L and the capacitor Cs are connected in series on a transmission line and a form in which a capacitor Cp is connected between a line and an earth at both ends in parallel like the equivalent circuit model, and as a result, the respective short-circuit stubs 100 serve as the low-frequency band pass filter that passes the low-frequency RF signal and rejects a relatively higher-frequency stop band without a change in electrical length to thereby effectively remove the spurious or harmonic components.

An electrical filtering feature of the short-circuit stub 100 may be controlled by appropriately designing the length of the groove in the signal progress direction Z the width or the depth of the groove in the direction X vertical to the signal progress direction Z and even besides, the short-circuit stub 100 passes a relative predetermined low frequency even according to a separation distance between two (alternatively, or more) short-circuit stubs 100 to effectively remove the spurious or harmonic components depending on the corresponding band on a transmission line of the signal progress direction Z. As described above, in the present invention, the filter for rejecting the stop band is not separately configured before or after the waveguide resonator and the waveguide resonator itself rejects the stop band, and as a result, the entire size of the filter does not increase.

Internal spaces, holes, or grooves of input and output terminals 10 and 20, the inductive iris 30, the resonator 50, the short-circuit stubs 100, and the like constituting the waveguide resonator according to the exemplary embodiment of the present invention described above may have a cavity form which is vacant so that the RF signal is progressed in the resonance mode and as necessary, a form in which the internal spaces, the holes, or the grooves are filled with the dielectric having a predetermined dielectric constant so that the RF signal penetrates the internal spaces, the holes, or the grooves.

FIG. 3 illustrates an example of a 12-th band pass filter using the waveguide resonator having the short-circuit stub 100 incorporated therein according to an exemplary embodiment of the present invention.

The waveguide resonator of the present invention illustrated in FIG. 3 includes 12 resonators 50 between the input terminal 10 and the output terminal 20 described in FIGS. 1A to 1C and the inductive iris 30 is coupled between the resonators 50 and the respective resonators at both ends are also coupled through the terminal 10/20 and the inductive iris 30. Two short-circuit stubs 100 described above are provided in each of the resonators 50.

Herein, the 12-th band pass filter is described as an example, but the present invention is not limited thereto and it is revealed that the resonators 50 may be constituted by an appropriate plurality of, that is, two or more resonators as necessary. Further, although not illustrated in the figure, when an electrical feature of a designed waveguide resonator is different from a preanalyzed result, predetermined tuning screws for tuning the electrical feature or a frequency feature may be provided in the resonators 50. For example, resonator impedance may be controlled according to lengths of protrusion ends of the tuning screws which are pushed into the resonator by turning the tuning screws provided in the resonators 50, and as a result, an electrical length between the resonators 50, an electrical length between the inductive irises 30, or an electrical length between the plurality of short-circuit stubs 100 is controlled to correct the electric feature to a desired electrical filter feature.

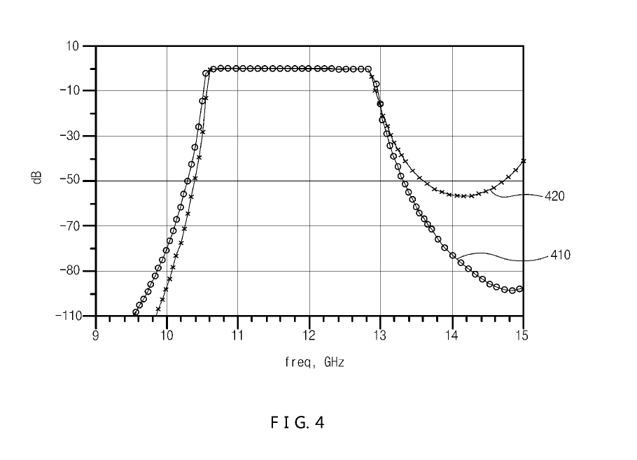

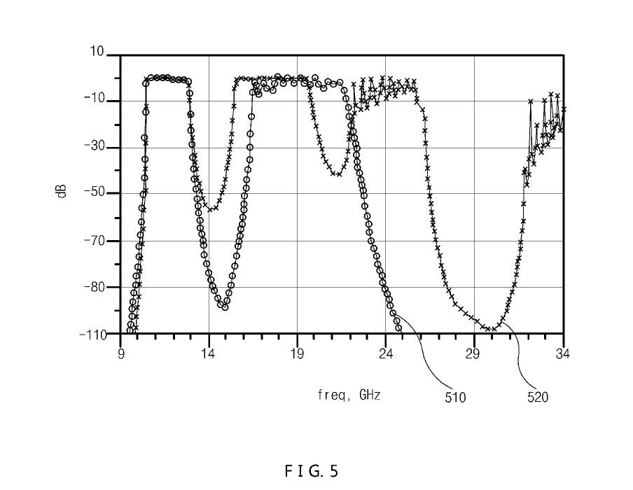

FIG. 4 is an electrical transfer feature graph in a Ku band (e.g., 9 to 14 GHz) of the 12-th band pass filter of FIG. 3 using the waveguide resonator having the short-circuit stub 100 incorporated therein according to the exemplary embodiment of the present invention. Reference numeral 410 illustrates a case of the 12-th band pass filter of FIG. 3 with the short-circuit stub 100 and reference numeral 420 illustrates a case of the 12-th band pass filter without the short-circuit stub 100.

The frequency of 14 GHz corresponds to a transmission band frequency of the Ku band and transfer features with and without the short-circuit stubs 100 show a difference of 26 dB or more. Accordingly, it can be seen that the 12-th band pass filter of FIG. 3 band-passes a satellite communication reception band (e.g., 10.7 to 12.75 GHz) and the rejection performance is exceptionally improved with respect to the transmission band.

FIG. 5 is an electrical transfer feature graph in a wide frequency domain (e.g., 9 to 34 GHz) of the 12-th band pass filter using the waveguide resonator having the short-circuit stub 100 incorporated therein according to the exemplary embodiment of the present invention. Reference numeral 510 illustrates the case of the 12-th band pass filter of FIG. 3 with the short-circuit stub 100 and reference numeral 520 illustrates the case of the 12-th band pass filter without the short-circuit stub 100. Herein, it is verified that a result of using the short-circuit stub 100 may remove the harmonic component generated around 24 GHz and 34 GHz.

From results of FIGS. 4 and 5 described above, it can be seen that the short-circuit stub 100 proposed in the present invention is used to improve the rejection performance in the stop band and effectively remove the harmonic components.

As described above, the waveguide resonator for the band pass filter of the present invention passes the low frequency and reject the stop band by the short-circuit stub 100 during the band pass filtering (e.g., reception band passing) in the duplexer using both transmission and reception bands like the satellite communication to effectively remove the spurious or harmonic components and further, since in addition to improvement of electrical performance, a short-circuit stub 100 can be integrally provided together with a waveguide or a resonator 50, an entire size of the filter does not increase and since an integrated body including the short-circuit stub can be simultaneously processed at the time of mechanically processing the filter, the waveguide resonator is easily manufactured and reproducibility is also excellent.

The present invention has been described by the specified matters and limited embodiments and drawings such as specific components in the present invention, which are provided to help overall understanding of the present invention and is not limited thereto, and those skilled in the art will appreciate that various modifications and changes can be made within the scope without departing from an essential characteristic of the present invention. The spirit of the present invention is defined only the exemplary embodiments described above and it should be appreciated that all technical spirits which are equivalent to the appended claims in addition to the appended claims to be described below are included in the claims of the present invention.

What is claimed is:

1. A waveguide resonator for band pass filtering, comprising:
a resonator coupled in a resonance mode through inductive irises at both sides between an input terminal and an output terminal; and
a short-circuit stub formed on one surface of the resonator vertically to an RF signal progress direction.

2. The waveguide resonator of claim 1, wherein the RF signal is transmitted in a TE₁₀ mode.

3. The waveguide resonator of claim 1, wherein the resonator has a cavity form or a form in which the resonator is filled with a dielectric.

4. The waveguide resonator of claim 1, wherein the short-circuit stub is used to remove spurious or harmonic components.

5. The waveguide resonator of claim 1, wherein the short-circuit stub is a low-frequency band pass filter.

6. The waveguide resonator of claim 1, wherein in the short-circuit stub, a corresponding groove has a predetermined length, width, or depth to achieve a predetermined electrical feature.

7. The waveguide resonator of claim 1, wherein the waveguide resonator has a structure in which the plurality of short-circuit stubs are formed on one surface of the resonator and the plurality of corresponding short-circuit stubs are separated by a predetermined distance to achieve the predetermined electrical feature.

8. The waveguide resonator of claim 1, wherein the waveguide resonator has a structure in which the plurality of resonators are formed between the input terminal and the output terminal and the plurality of corresponding resonators are coupled to each other in the resonance mode through the irises.

9. A waveguide filter comprising:
a band pass filter formed by a waveguide resonator; and
a low-frequency band pass filter having a short-circuit stub form, which is formed integrally with the band pass filter,
wherein the waveguide filter is applied to a satellite communication duplexer to receive an RF signal in a reception band through the band pass filter and used to remove spurious or harmonic components through the low-frequency band pass filter.

10. A method for receiving an RF signal by using a waveguide resonator, the method comprising:
band-pass-filtering an RF signal by using a resonator coupled in a resonance mode through inductive irises at both sides between an input terminal and an output terminal; and
passing a low frequency and removing spurious or harmonic components by using a short-circuit stub formed on one surface of the resonator vertically to an RF signal progress direction.

11. The method of claim 10, wherein the RF signal is transmitted in a TE₁₀ mode through the resonator.

12. The method of claim 10, wherein the resonator has a cavity form or a form in which the resonator is filled with a dielectric.

13. The method of claim 10, wherein in the short-circuit stub, a corresponding groove has a predetermined length, width, or depth to achieve a predetermined electrical feature.

14. The method of claim 10, wherein the plurality of short-circuit stubs is formed on one surface of the resonator and the plurality of corresponding short-circuit stubs is separated by a predetermined distance to achieve the predetermined electrical feature.

15. The method of claim 10, wherein the plurality of resonators are formed between the input terminal and the output terminal and the plurality of corresponding resonators are coupled to each other in the resonance mode through the inductive irises.
